(19) United States
(12) Patent Application Publication
(10) Pub. No.: US 2005/0134022 A1
(43) Pub. Date: Jun. 23, 2005

(54) Curtain airbag device

(75) Inventors: Atsushi Noguchi, Moriyama-shi (JP); Tetsu Mitsuo, Nissin-shi (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 11/013,412

(22) Filed: Dec. 17, 2004

(30) Foreign Application Priority Data
Dec. 19, 2003 (JP) 2003-423084

(51) Int. Cl. B60R 21/22

(52) U.S. Cl. 280/728.2; 280/730.2

(57) ABSTRACT

A curtain airbag device maintains an elevated internal pressure of a curtain airbag for many hours. When an inflator is activated, a curtain airbag is deployed downward along an inner side surface of a vehicle cabin. During the deployment, a duct of the inflator is inserted into a gas inlet of the curtain airbag and is clamped with a clamp such as a band. Elastic adhesives are disposed on grooves in the inner surface of the gas inlet along the ends of a linear connected portion. As a result, the likelihood of gas leakage from the space between the inner surface of the gas inlet and the outer circumference of the duct is reduced.

### BACKGROUND

The present invention relates to curtain airbag devices provided with curtain airbags that are capable of being deployed along inner side surfaces of vehicle cabins.

In a vehicle provided with a curtain airbag device, when the vehicle is involved in, for example, a side-on collision or rollover, curtain airbags are deployed downward along an inner side surface (for example, a door and a pillar) of the vehicle cabin so as to protect the head of the vehicle occupant and to keep the vehicle occupant inside the vehicle cabin.

U.S. Pat. No. 6,237,938 discloses a guide member provided on a C pillar for guiding downward (along the pillar) a rear portion of a curtain airbag, which is inflatable along the inner side surface of the vehicle cabin. Moreover, the guide member in U.S. Pat. No. 6,237,938 (incorporated by reference herein) includes a track having a box-shaped cross-section and a slider (as referred to as an “element”) that is movably arranged in the track in the longitudinal direction of the track. The rear end portion of the curtain airbag is tied to the slider. To prevent the rear edge portion of the curtain airbag, which is moved downward, from being retracted upward, latches are arranged at regular intervals along substantially the entire length of the track. The top and bottom ends of the track are provided with mounting flanges; each of the flanges is fixed to the C pillar with a bolt or a screw.

Japanese Unexamined Patent Application Publication No. 2001-270413 (incorporated by reference herein) discloses a structure in which a gas generator is inserted into a gas inlet of a curtain airbag. The gas generator and the gas inlet are clamped together with a metal fitting at the periphery so as to be connected to each other.

Unfortunately, as a result of the structures provided in U.S. Pat. No. 6,237,938 and Japanese Unexamined Patent Application Publication No. 2001-270413, when the curtain airbag is inflated, gas may leak from the curtain airbag through the interface between the gas inlet and the gas generator. As a result, a high (also referred to as “elevated”), i.e., greater than atmospheric pressure, internal pressure of the curtain airbag cannot be maintained for a long period of time, e.g., several hours.

Accordingly, the present invention has been made in light of the aforementioned problems. It is an object of the present invention to provide a curtain airbag device in which gas leakage from a gas inlet of a curtain airbag is prevented (or at least greatly inhibited) so as to maintain an elevated internal pressure of the curtain airbag for a long period of time.

### SUMMARY

According to an embodiment of the invention curtain bag device is provided. The device includes: a curtain airbag having a gas inlet, wherein the curtain airbag is configured to be deployed downward along an inner side surface of a vehicle cabin; a gas generator configured to supply gas from the gas inlet into the curtain airbag; and an insertion block composed of a duct that communicates with the gas generator. The insertion block and the gas inlet are clamped with a clamp from the outside of the gas inlet so as to be connected to each other. The gas generator or the insertion block is inserted into the gas inlet. A seal is disposed on the inner surface of the gas inlet.

In a further embodiment of the curtain airbag, the seal may be composed of an elastic adhesive or soft rubber.

In another further embodiment of the curtain airbag, the curtain airbag may be formed of two layers of sheets connected to each other at least at the periphery. Further, the gas inlet may be formed by connecting the sheets at a linear connected portion. The seal may be disposed on portions in the inner surface of the gas inlet along the linear connected portion.

Another embodiment of the invention is directed to a curtain airbag device that includes: a curtain airbag having a gas inlet, wherein the curtain airbag is configured to be deployed downward along an inner side surface of a vehicle cabin; a gas generator configured to supply gas from the gas inlet into the curtain airbag; and an insertion block that communicates with the gas generator. The insertion block and the gas inlet are clamped with a clamp from the outside of the gas inlet so as to be connected to each other. The gas generator or the insertion block is inserted into the gas inlet. A seal is disposed on the inner surface of the gas inlet.

In a further embodiment of this airbag cushion device, the seal may be composed of an elastic adhesive or rubber.

In another further embodiment of this airbag cushion device, the curtain airbag may be formed of two layers of sheets connected to each other at least at a periphery thereof. Further, the gas inlet may be formed by connecting the sheets along a connected portion; the seal may be disposed on at least a portion of an inner surface of the gas inlet along the connected portion.

In another further embodiment of this airbag cushion device, the device may also include a guide member that is configured to be vertically attached to a pillar of a vehicle and that is configured to guide the curtain airbag during the downward deployment.

Another embodiment of the invention addresses a curtain airbag device that includes, among other possible things: (a) a curtain airbag having a gas inlet; (b) a gas generator configured to supply gas through the gas inlet and into the curtain airbag; (c) an insertion block that communicates with the gas generator and the curtain airbag; and (d) a clamp that clamps the insertion block in the gas inlet from the outside of the gas inlet so that the insertion block and an inner surface of the gas inlet are joined. The curtain airbag is configured to be deployed downward along an inner side surface of a vehicle cabin. A seal is disposed on the inner surface of the gas inlet. The seal is of sufficient strength to maintain an internal pressure of the curtain airbag at an elevated level for at least one hour after deployment of the curtain airbag.

In a further embodiment of this curtain airbag device, the seal may include an elastic adhesive.

In another further embodiment of this curtain airbag device, the curtain airbag may be formed of two layers of sheets connected to each other at least at a periphery thereof. Further, the gas inlet may be formed by connecting the sheets along a connected portion. In addition, the seal may be disposed on at least a portion of the inner surface of the gas inlet along the connected portion.

In another further embodiment of this curtain airbag device, the curtain airbag device may also include a guide member that is configured to be vertically attached to a pillar of a vehicle. Further, the guide member may be configured to guide the curtain airbag during the downward deployment.

Another embodiment of the invention is directed to a vehicle that includes: a vehicle cabin; and a curtain airbag device that includes, a curtain airbag installed along an inner side surface of the vehicle cabin, the curtain airbag having a gas inlet; a gas generator configured to supply gas through the gas inlet and into the curtain airbag; an insertion block that communicates with the gas generator and the curtain airbag; and a clamp that clamps the insertion block in the gas inlet from the outside of the gas inlet so that the insertion block and an inner surface of the gas inlet are joined. The curtain airbag is configured to be deployed downward along an inner side surface of the vehicle cabin. A seal is disposed on the inner surface of the gas inlet. The seal is of sufficient strength to maintain an internal pressure of the curtain airbag at an elevated level for at least one hour after deployment of the curtain airbag.

In a further embodiment of the vehicle, the seal may include an elastic adhesive.

In another further embodiment of the vehicle, the curtain airbag may be formed of two layers of sheets connected to each other at least at a periphery thereof. Further, the gas inlet may be formed by connecting the sheets along a connected portion. In addition, the seal may be disposed on at least a portion of the surface of the gas inlet along the connected portion.

In another further embodiment of the vehicle, the curtain airbag device may also include a guide member that is configured to be vertically attached to a pillar of the vehicle cabin. Further, the guide member may be configured to guide the curtain airbag during the downward deployment.

The curtain airbag embodiments (and vehicles incorporating them) described herein have several advantages. For example, the intervening seal between the gas inlet and the insertion block, i.e. a gas generator or a duct communicating therewith, can prevent (or at least greatly inhibit) gas leakage from the interface between the gas inlet and the insertion block. Accordingly, when the curtain airbag is inflated, the internal pressure of the curtain airbag can be kept elevated for many hours.

By way of further example, the seal is disposed on the inner surface of the gas inlet so that the insertion block can easily be installed in the gas inlet.

By way of further example, when the seal is composed of an elastic adhesive and the gas inlet is clamped by a clamp from the outside, the seal spreads along the outer circumference of the insertion block. Accordingly, the sealing performance between the inner surface of the gas inlet and the outer circumference of the insertion block is remarkably improved.

By way of further example, the elastic adhesive may be non-glutinous. As a result, when the insertion block can be smoothly inserted into the gas inlet.

By way of further example, according to an embodiment of the present invention in which the curtain airbag is formed of two layers of sheets connected to each other at least at the periphery, the gas inlet may be formed by connecting the sheets at a linear connected portion. The seal may be disposed on portions in the inner surface of the gas inlet along the linear connected portion. The seal can sufficiently seal the air gap that is formed along the linear connected portion.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1A is a side view of an embodiment of curtain airbag according to the present invention; FIG. 1B is a cross-section view of the airbag of FIG. 1A taken along line B-B;

FIG. 2 is an enlarged view of a portion around a gas inlet of the curtain airbag of FIGS. 1A and 1B;

FIG. 3A is a cross-sectional view taken along line III-III in FIG. 2; FIGS. 3B and 3C are respective enlarged views around a B portion and a C portion in FIG. 3A;

FIG. 4 is an exploded perspective view around the gas inlet of de curtain airbag shown in FIGS. 1A, 1B, and 2;

FIG. 5 is a cross-sectional view of the gas inlet taken along line V-V in FIG. 4; and

FIG. 6 is a schematic side view illustrating a vehicle cabin provided with a curtain airbag device such as the embodiment shown in FIGS. 1-5.

### DETAILED DESCRIPTION

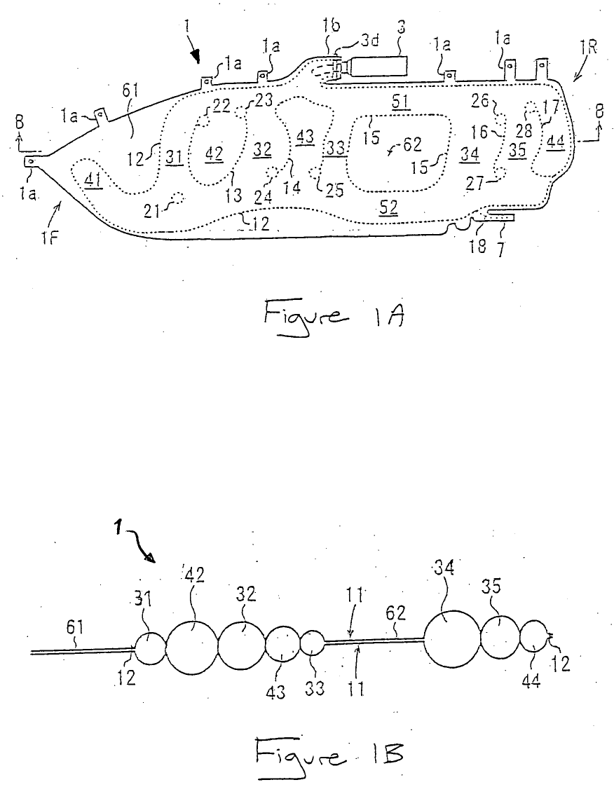

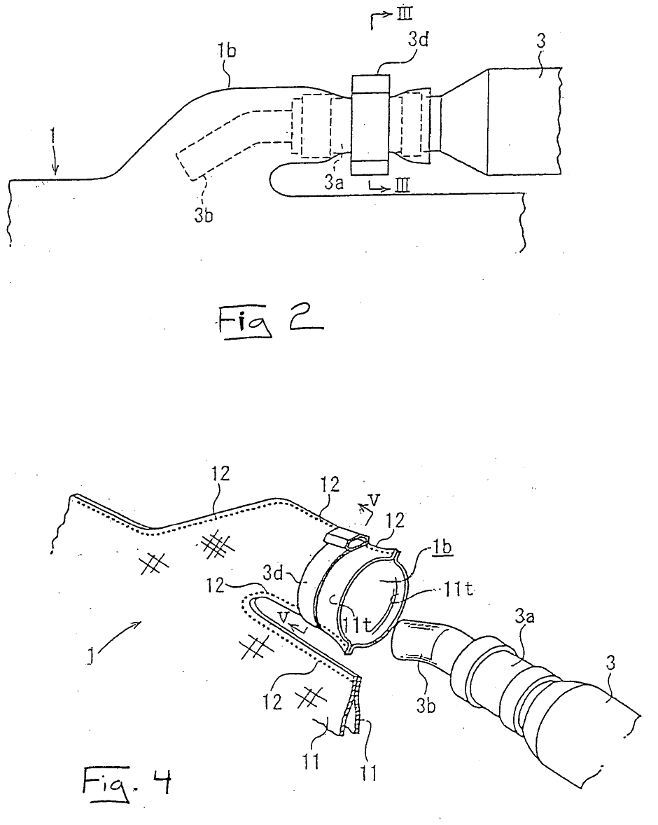

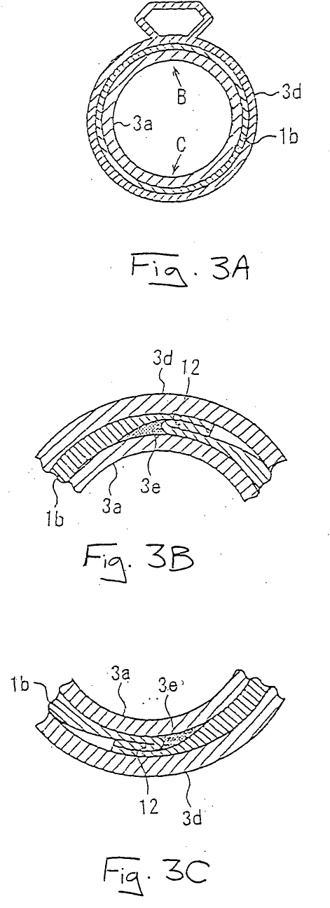

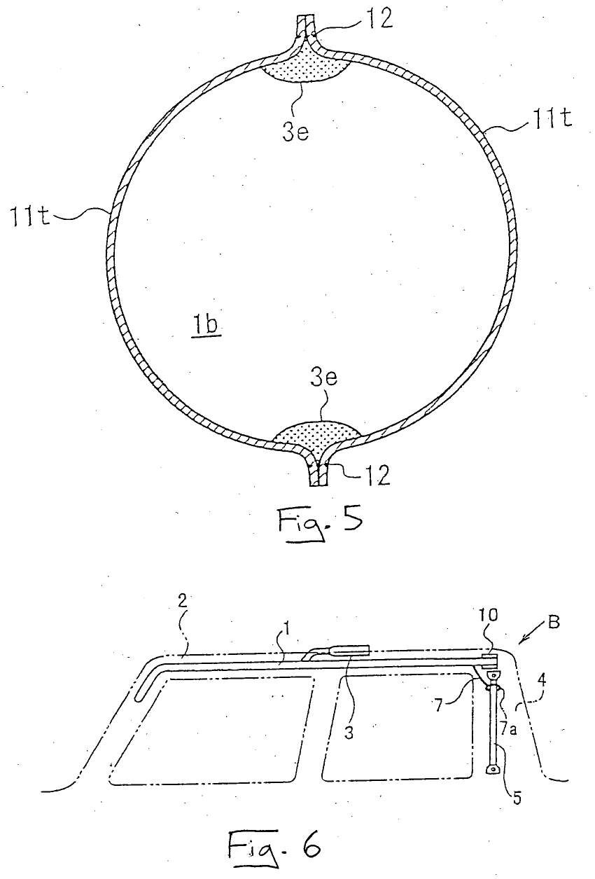

Embodiments of the present invention will be described hereinafter with reference to the drawings. FIG. 1A is a side view illustrating a state in which the curtain airbag is inflated. FIG. 1B is a cross-sectional view taken along line B-B in FIG. 1A. FIG. 2 is an enlarged view illustrating a portion around a gas inlet. FIG. 3A is a cross-sectional view taken along line III-III in FIG. 2. FIGS. 3B and 3C are enlarged views around a B portion and a C portion in FIG. 3A, respectively. FIG. 4 is an exploded perspective view around the gas inlet. FIG. 5 is a cross-sectional view of the gas inlet taken along line V-V in FIG. 4. In FIG. 5, the clamp shown in FIG. 4 is not illustrated. FIG. 6 is a schematic side view illustrating a vehicle cabin provided with a curtain airbag device.

As shown in FIG. 6, a curtain airbag 1 is disposed along a roof side 2 of a vehicle (border section between the ceiling and inner side surface of a vehicle cabin) while being folded in a slender manner in the longitudinal direction of the vehicle. A roof-side garnish (not shown) is disposed on the roof side 2, and covers the curtain airbag 1.

When a vehicle is involved in a side-on collision or a rollover, for example, the curtain airbag 1 is inflated as a result of gas being sent from an inflator 3 (gas generator). The curtain airbag 1 is deployed in the downward direction of the vehicle body along the side surface, i.e. doors and pillars, in the vehicle cabin. An upper edge of the curtain airbag 1 is provided with tabs 1a (shown in FIG. 1A) that are fastened to the roof side 2.

The central portion of the upper edge of the curtain airbag 1, with respect to the longitudinal direction, is provided with a projection that extends upward and that comprises a gas inlet 1b. A tip portion of the inflator 3 is inserted through the gas inlet 1b and is clamped thereto with a clamp 3d such as, e.g., a band.

As shown in FIG. 2, a nozzle 3b, which has a substantially dog-leg shape, is connected to the tip of the inflator 3 via an intervening duct 3a having an approximately cylindrical shape. Together the duct 3a and the nozzle 3b define an insertion block.

Elastic adhesives 3e functioning as seals are disposed on the inner surface of the gas inlet 1b. The nozzle 3b and the duct 3a are inserted into this gas inlet 1b, and are clamped with the clamp 3d such as a band from the outer circumference of the gas inlet 1b. Accordingly, the gas inlet 1b and the inflator 3 are hermetically sealed and firmly combined with each other.

With respect to FIG. 1B, the curtain airbag 1 in this embodiment is formed of two layers of sheets 11. These two sheets 11 are connected to each other at, for example, the periphery, via a linear connected portion 12 (shown in FIG. 1A) and the like so as to form a pouched shape. The linear connected portion 12 may be, for example, in the form of stitching through the sheets 11.

As shown in FIGS. 4 and 5, in the vicinity of the gas inlet 1b, projections 11t extend upward from the upper edges of the sheets 11. The projections 11t are connected to each other by the linear connected portion 12 at the upper edges and the lower edges so as to form the gas inlet 1b. The gas inlet 1b is opened by separating the projections 11t from each other. When the gas inlet 1b is opened, grooves are formed along the ends of the linear connected portion 12. As shown in FIG. 5, the elastic adhesives 3e may be disposed in and around the grooves.

After the nozzle 3b and the duct 3a are inserted into the gas inlet 1b, they are clamped from the outside of the gas inlet 1b with the clamp 3d. As a result, as shown in FIGS. 3B and 3C, the sections of elastic adhesive 3e spread along the outer circumference of the duct 3a. As a result, the space between the inner surface of the gas inlet 1b and the outer circumference of the duct 3a is hermetically sealed around the grooves. Accordingly, gas leakage from the space between the inner surface of the gas inlet 1b and the outer circumference of the duct 3a can be reliably prevented (or at least greatly inhibited).

As shown in FIG. 6, a C pillar 4 of the vehicle has a guide rod 5 attached thereto. The guide rod functions as a guide element for guiding the rear portion of the curtain airbag 1 along the C pillar 4 while the curtain airbag 1 is being deployed along the C pillar 4 in the downward direction of the vehicle body. The guide rod 5 has a rod-like structure that extends along the C pillar 4 in the vertical direction of the vehicle body. Both the upper and lower ends of the guide rod 5 are fixed to the C pillar 4 with, for example, bolts.

Furthermore, a pillar trim or garnish (not shown) covers the cabin-side of the C pillar 4. The door-frame portion of the C pillar 4 has a weather strip (not shown) attached thereto. A lateral edge of the pillar garnish is in contact with the weather strip. The roof side 2 is provided with a roof-side garnish (not shown) that covers the curtain airbag 1. The roof-side garnish abuts against the pillar garnish.

A curtain-guide member 10, also known as a jump base, is disposed on the roof side 2 above the C pillar 4. At the beginning of deployment of the curtain airbag 1, the curtain-guide member 10 allows the curtain airbag 1 to pass over the top of the pillar garnish so as to guide the curtain airbag 1 towards the interior of the vehicle cabin.

As shown in FIGS. 1A and 1B, the curtain airbag 1 is formed by overlapping two sheets 11, 11 having substantially the same shape, such that one of the sheets faces an inner side surface of the vehicle cabin and the other faces the interior of the vehicle cabin. The two sheets 11, 11 are connected to each other by connected portions 12-18 and circular connected portions 21-28 so as to form vertical chambers 30-34, bag chambers 41-44, horizontal chambers 51, 52, and non-inflatable portions 61, 62. Each of the connected portions 12-18, 21-28 may be, for example, lines of stitching.

A link strap 7 protrudes from a rear portion of the curtain airbag 1 in the vicinity of a bottom corner thereof. Specifically, the link strap 7 positioned below the first vertical chamber 30 of the curtain airbag 1. Further, the link strap 7 is formed by extending the sheets 11, 11 in an elongated shape and joining them together by the connected portion 18, which is later described in detail. An extremity of the link strap 7 is provided with a loop 7a (shown in FIG. 6) that is loosely tied around the guide rod 5. The loop 7a is movable vertically along the guide rod 5. Alternatively, the extremity of the link strap 7 may be provided with a ring (not shown), the ring being set around the guide rod 5.

The connected portions 12-18 and the circular connected portions 21-28 hermetically join the sheets 11, 11 together. For the connection between the two sheets 11, 11, high-strength connecting means (such as stitching with high-strength threads, bonding with an adhesive having high adhesivity, or welding) may be used so that two sheets 11, 11 are unable to separate from each other even when the pressure inside the curtain airbag 1 reaches the upper limit pressure value.

The connected portion 12 extends substantially around the curtain airbag 1, but at a front portion 1F of the curtain airbag 1, the connected portion 12 extends downward from the upper edge of the front portion 1F so as to form a substantially U-shape. This forms the non-inflatable portion 61 along the upper edge of the front portion 1F and the bag chamber 41 at the frontmost part of the front portion 1F. The connected portion 12 extends along an edge of the projection 11t of the curtain airbag 1, but is interrupted at the rear edge of the projection 11t so as to form the gas inlet 1b of the curtain airbag 1.

The connected portion 13 is disposed slightly towards the front of the curtain airbag 1 with respect to the center of the curtain airbag 1. The connected portion 13 is U-shaped, and its inner region forms the bag chamber 42. The upper portion of the bag chamber 42 communicates with the gas inlet 1b, whereas the lower portion has no openings.

The connected portion 13 and the peripheral connected portion 12 at the front portion 1F of the curtain airbag 1 have the vertical chamber 31 disposed therebetween. The upper portion of the vertical chamber 31 communicates with the gas inlet 1b, and the lower portion communicates with the bag chamber 41 and with the lower portion of the vertical chamber 32, which will later be described in detail. To prevent the lower portion of the vertical chamber 31 from being over-inflated, the circular connected portion 21 is provided.

The connected portion 14 has an inverted U-shape and is disposed at the central portion of the curtain airbag 1 with respect to the longitudinal direction of the airbag 1. The inner region of the connected portion 14 forms the bag chamber 43. The lower portion of the bag chamber 43 communicates with the lower portions of the vertical chambers 32 and 33, whereas the upper portion of the bag chamber 43 has no openings.

The connected portion 14 and the connected portion 13 have the vertical chamber 32 disposed therebetween. The upper portion of the vertical chamber 32 communicates with the gas inlet 1b.

The connected portion 15 is disposed slightly towards the back of the curtain airbag 1 with respect to the center of the curtain airbag 1. The connected portion 15 is substantially square-shaped. The upper edge and the lower edge of the connected portion 15 are respectively not in contact with the upper edge and the lower edge of the connected portion 12. Thus, the horizontal chamber 51 is formed between the upper edge of the connected portion 12 and the upper edge of the connected portion 15, and the horizontal chamber 52 is formed between the lower edge of the connected portion 12 and the lower edge of the connected portion 15.

The connected portion 15 and the connected portion 14 have the vertical chamber 33 disposed therebetween. The upper portion of the vertical chamber 33 communicates with the front portion of the horizontal chamber 51 and with the gas inlet 1b. The lower portion of the vertical chamber 33 communicates with the lower portion of the bag chamber 43 and the front portion of the horizontal chamber 52.

The inner region of the connected portion 15 is cut off from the gas inlet hole 1b so as to form the non-inflatable portion 62.

At the rear portion of the curtain airbag 1, the connected portion 16 is disposed and extends generally vertically. Moreover, further towards the back of the curtain airbag 1, the connected portion 17 having a generally L-shape is disposed.

The connected portions 15 and 16 have vertical chamber 34 disposed therebetween. The upper and lower portions of the vertical chamber 34 respectively communicate with the horizontal chambers 51 and 52. The link strap 7 is positioned below the vertical chamber 34. Moreover, slender portions extending from the sheets 11, 11 are combined via the linear connected portion 18 so as to form the link strap 7.

The connected portions 16 and 17 have the vertical chamber 35 disposed therebetween. The upper and lower portions of the vertical chamber 35 respectively communicate with the upper and lower portions of the vertical chamber 34. Alternatively, the vertical chamber 35 may be bag-shaped such that only the lower portion communicates with the lower portion of the vertical chamber 34.

The bag chamber 44 is formed between the connected portion 17 and a part of the connected portion 12 extending along a rear portion 1R of the curtain airbag 1. The upper portion of the bag chamber 44 communicates with the upper portion of the vertical chamber 35, whereas the lower portion of the bag chamber 44 has no openings. Alternatively, the lower portion of the bag chamber 44 may communicate with the lower portion of the vertical chamber 35.

Both ends of each of connected portions 13, 14, and 16, are provided with circular connected portions 22-27 for reinforcement. An upper end of connected portion 17 is provided with a circular connected portion 28, whereas the lower end of the connected portion 17 is connected with the connected portion 12.

When a vehicle provided with such a curtain airbag device is involved in a side-on collision or a rollover, the inflator 3 generates gas so as to inflate the curtain airbag 1. The curtain airbag 1 pushes open the roof-side garnish, and the curtain-guide member 10 allows the curtain airbag 1 to pass over the top of the pillar garnish so as to guide the curtain airbag 1 towards the interior of the vehicle cabin. Subsequently, the curtain airbag 1 begins to be deployed downward along the cabin-side of a pillar garnish.

The rear portion of the deploying curtain airbag 1 is guided by the guide rod 5 via the link strap 7. The link strap 7 starts moving downward along the guide rod 5 when the curtain airbag 1 begins to be deployed. In this case, as the curtain airbag 1 is being deployed, the link strap 7 moves downward while ripping through the pillar garnish and the weather strip.

Furthermore, the link strap 7 moves downward along the guide rod 5 with the curtain airbag 1 until the curtain airbag 1 reaches the bottommost point of deployment. As the link strap 7 connects the curtain airbag 1 and the guide rod 5 together, the curtain airbag 1 can be deployed along the corresponding side surface of the vehicle cabin.

In this embodiment, the elastic adhesives 3e, which function as seals, are disposed on the inner surface of the gas inlet 1b. Accordingly, gas leakage from the space between the outer circumference of the duct 3a and the inner surface of the gas inlet 1b can be prevented (or at least greatly inhibited). As a result, an elevated internal pressure of the curtain airbag 1 can be maintained for several hours.

In this embodiment, as the elastic adhesive 3e must only be disposed on the grooves along the ends of the linear connected portion 12, only a small amount of adhesive is required. More specifically, much less adhesive 3e is necessary as compared to a situation in which adhesive is disposed on the whole circumference of the inner surface of the gas inlet 1b, the nozzle 3b and the duct 3a. Moreover, as a result of the limited amount of adhesive necessary, the duct 3a can be smoothly inserted into the gas inlet 1b.

In this embodiment, the elastic adhesive 3e may be employed as bonding agents. Therefore, when the clamp 3d is clamped, the elastic adhesive 3e may spread so as to seal air gaps sufficiently hermetically. Various commercial adhesives such as silicon-based elastic adhesives may be employed as the elastic adhesive. In addition, it is preferable that the chosen adhesive have both excellent heat resistance and excellent weather resistance.

The technical scope of the present invention is not limited to the embodiments described herein. Rather, modifications are permissible within the scope and spirit of the present invention. For example, the number and positions of the vertical chambers and the position of the gas inlet are not limited to those shown in the drawings. For example, the present invention is applicable to the case where the tip of the gas generator is directly inserted into the gas inlet.

The priority application, Japanese Application 2003-423084, which was filed Dec. 19, 2003, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. A curtain airbag device comprising:
a curtain airbag having a gas inlet, wherein the curtain airbag is configured to be deployed downward along an inner side surface of a vehicle cabin;
a gas generator configured to supply gas from the gas inlet into the curtain airbag; and
an insertion block that communicates with the gas generator,
wherein the insertion block and the gas inlet are clamped with a clamp from the outside of the gas inlet so as to be connected to each other, wherein the gas generator or the insertion block is inserted into the gas inlet, and wherein a seal is disposed on the inner surface of the gas inlet.

2. The curtain airbag device according to claim 1, wherein the seal is composed of an elastic adhesive.

3. The curtain airbag device according to claim 1, wherein the curtain airbag is formed of two layers of sheets connected to each other at least at a periphery thereof, wherein the gas inlet is formed by connecting the sheets along a connected portion, and wherein the seal is disposed on at least a portion of an inner surface of the gas inlet along the connected portion.

4. The curtain airbag device according to claim 1, further comprising:
a guide member that is configured to be vertically attached to a pillar of a vehicle, and that is configured to guide the curtain airbag during the downward deployment.

5. A curtain airbag device comprising:
a curtain airbag comprising a gas inlet;
a gas generator configured to supply gas through the gas inlet and into the curtain airbag;
an insertion block that communicates with the gas generator and the curtain airbag; and
a clamp that clamps the insertion block in the gas inlet from the outside of the gas inlet so that the insertion block and an inner surface of the gas inlet are joined,
wherein the curtain airbag is configured to be deployed downward along an inner side surface of a vehicle cabin,
wherein a seal is disposed on the inner surface of the gas inlet, and
wherein the seal is of sufficient strength to maintain an internal pressure of the curtain airbag at an elevated level for at least one hour after deployment of the curtain airbag.

6. No curtain airbag device according to claim 5, wherein the seal comprises an elastic adhesive.

7. The curtain airbag device according to claim 5, wherein the curtain airbag is formed of two layers of sheets connected to each other at least at a periphery thereof.

8. The curtain airbag device according to claim 7, wherein the gas inlet is formed by connecting the sheets along a connected portion.

9. The curtain airbag device according to claim 8, wherein the seal is disposed on at least a portion of the inner surface of the gas inlet along the connected portion.

10. The curtain airbag device according to claim 5, further comprising:
a guide member that is configured to be vertically attached to a pillar of a vehicle.

11. The curtain airbag device according to claim 10, wherein the guide member is configured to guide the curtain airbag during the downward deployment.

12. A vehicle comprising:
a vehicle cabin; and
a curtain airbag device comprising:
a curtain airbag installed along an inner side surface of the vehicle cabin, the curtain airbag comprising a gas inlet;
a gas generator configured to supply gas through the gas inlet and into the curtain airbag;
an insertion block that communicates with the gas generator and the curtain airbag; and
a clamp that clamps the insertion block in the gas inlet from the outside of the gas inlet so that the insertion block and an inner surface of the gas inlet are joined,
wherein the curtain airbag is configured to be deployed downward along an inner side surface of the vehicle cabin,
wherein a seal is disposed on the inner surface of the gas inlet, and
wherein the seal is of sufficient strength to maintain an internal pressure of the curtain airbag at an elevated level for at least one hour after deployment of the curtain airbag.

13. The vehicle according to claim 12, wherein the seal comprises an elastic adhesive.

14. The vehicle according to claim 12, wherein the curtain airbag is formed of two layers of sheets connected to each other at least at a periphery thereof.

15. The vehicle according to claim 14, wherein the gas inlet is formed by connecting the sheets along a connected portion.

16. The vehicle according to claim 15, wherein the seal is disposed on at least a portion of the inner surface of the gas inlet along the connected portion.

17. The vehicle according to claim 12, wherein the curtain airbag device further comprises:
a guide member that is configured to be vertically attached to a pillar of the vehicle cabin.

18. The vehicle according to claim 17, wherein the guide member is configured to guide the curtain airbag during the downward deployment.
